(19) United States
(12) Patent Application Publication
(10) Pub. No.: US 2003/0168356 A1
(43) Pub. Date: Sep. 11, 2003

(54) Artist paint brush case with removable paint brush hangers

(76) Inventor: Sam Usui, Greenwich, CT (US)

Correspondence Address: Alfred E. Miller, 2nd Floor, 74 Greenwich Avenue, Greenwich, CT, 06830, US

(21) Appl. No.: 10/090,022

(22) Filed: Mar. 5, 2002

(51) Int. Cl. B44D 3/00; B05C 17/00

(52) U.S. Cl. 206/1.7

(57) ABSTRACT

Artist paint brush box having brush hanger members fitted into the box whereby the brush handles are enlarged at the ends remote from the brushes to prevent the brushes from falling out of the hangers. The brush holders can be removed from the interior of the box and mounted for use on the exterior of the box.

This invention relates to a portable artist case or box having removable hangers for a plurality of artist brushes. The hangers are securely held in the case, but can be taken out with the brushes suspended there from and removably mounted on the exterior of one of the sides of the case.

### BACKGROUND OF THE INVENTION

Boxes or cases to accommodate artist paint brushes are known from U.S. Pat. No. 4,756,405 to Crozier; U.S. Pat. No. 3,077,977 to Wood; U.S. Pat. No. 4,573,569 to Parker and U.S. Pat. No. 5,797,489 to Baker, but none of these prior art patents show removable artist paint brush hangers that can also be used in conjunction with the box as an exterior stand for supporting paint brushes for use.

### SUMMARY OF THE INVENTION

The paintbrush hangers have a rectangular vertical support with a perpendicular ledge near the top of the support having openings for engaging and holding the end of the paintbrush handle. The handle of each of the artist paintbrush has an enlarged or bulbous extreme end, which has a diameter that is larger than the diameter of the openings in the ledge of the vertical support, so that the upper part of the handle will be supported on the edges of the ledge opening. Each rectangular hanger accommodates, for example, three brushes suspended there from. The hangers of certain dimensions frictionally fit in the box whereby the brushes are held and transported safely, but can be removed from the box and supported on the exterior of said box.

It is a feature of the present invention to provide an artist paint brush box having a cover and removable hangers for paint brushes in which the brushes are suspended by their handles.

It is another feature of the present invention to provide artist paint hangers, which frictionally fit between opposite interior sides of the box for storing and transporting the brushes.

A further object of the present invention is to provide handles for the artist paintbrush which are enlarged at the end remote from the brushes so that the brush handle will be supported in the unshaped opening in the ledge on the support member.

### DESCRIPTION OF THE DRAWINGS

In order that the invention may be more clearly understood, it will now be disclosed in greater detail with reference to the accompanying drawings, in which:

FIG. 1 is a front elavational view of an artist paint case constructed in accordance with the teachings of my invention.

FIG. 2 is a front elevational view of the artist paint case or box as seen in FIG. 1, but with the cover removed and the paint hangers with paint brushes inserted in the case for storage and transportation.

FIG. 3 is a rear elevational view of an artist paint case cover for a case or box shown in FIG. 2.

FIG. 4 is a side elevational view of the artist paint case with the cover removed.

FIG. 5 is a side elevational view of the cover of an artist paint case.

FIG. 6 is a front elevational view of an artist paintbrush hanger constructed in accordance with the teachings of my invention.

FIG. 7 is a rear elevational view of the hanger shown in FIG. 6.

FIG. 8 is a side elevational view of the artist paintbrush hanger shown in FIG. 6.

FIG. 9 is a top plan view of hanger shown in FIG. 6.

FIG. 10 is a front elevational view of a typical paintbrush having an enlargement on the extreme end of the paintbrush handle.

FIG. 11 is a rear elevational view of the paint brush case cover, and

FIG. 12 is a perspective view of the artist paintbrush case with a hanger having paint brushes suspended therefrom mounted on the rear of the case.

### DESCRIPTION OF THE PREFERRED EMBODIMENT

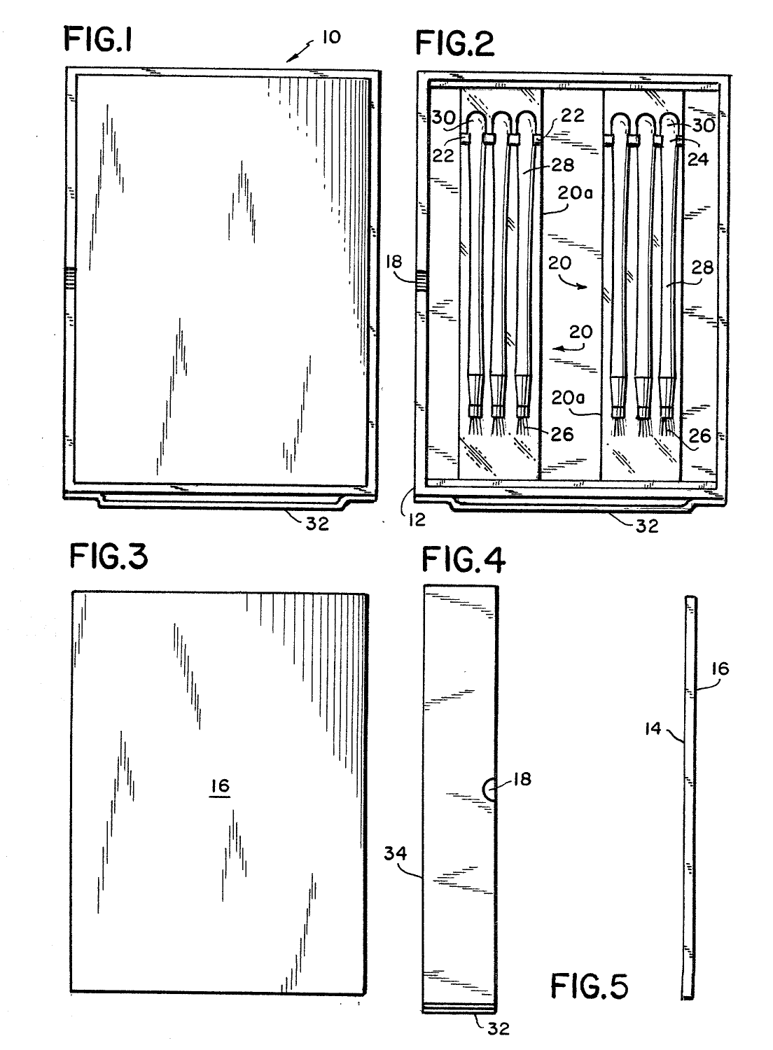

An artist paint brush case as seen in FIGS. 1-4 is referred to generally by the reference numeral 10 and which has a generally rectangular configuration. The open box 12 is provided with a cover 14. The cover 14 has an under layer 16 that is slightly smaller than the cover 14, as seen in FIG. 5, so that a peripheral recess is formed on the underside of the cover whereby the cover fits flush within the open box 12. As seen in FIGS. 2 and 4 the left side of the box 12 is provided with a finger recess 18 for lifting the flush cover 14 from the box 12.

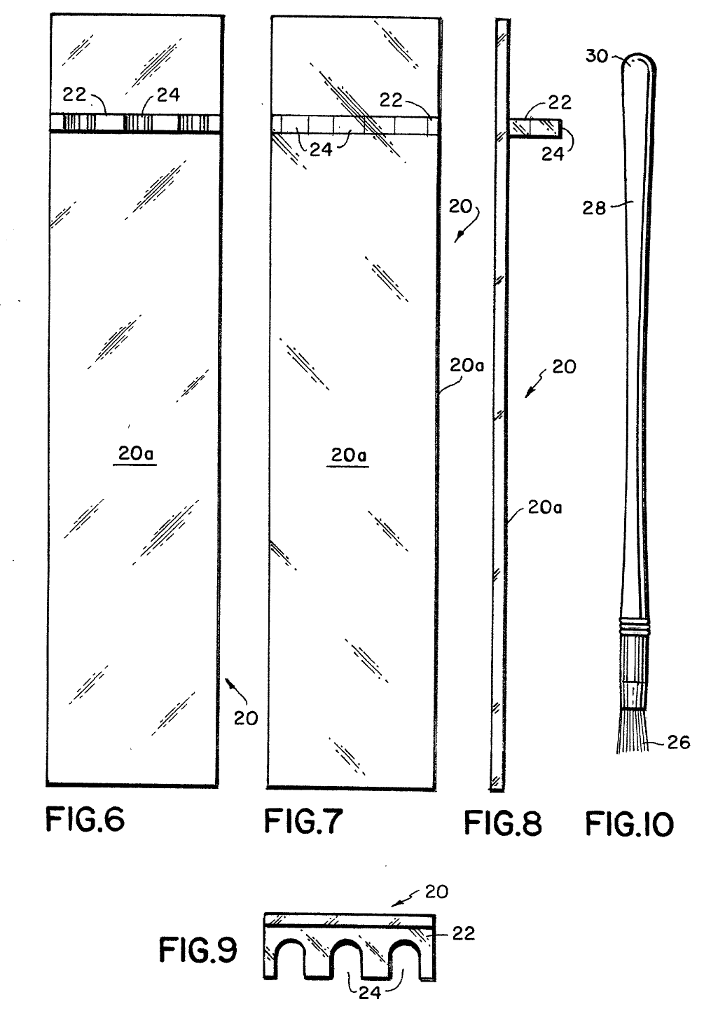

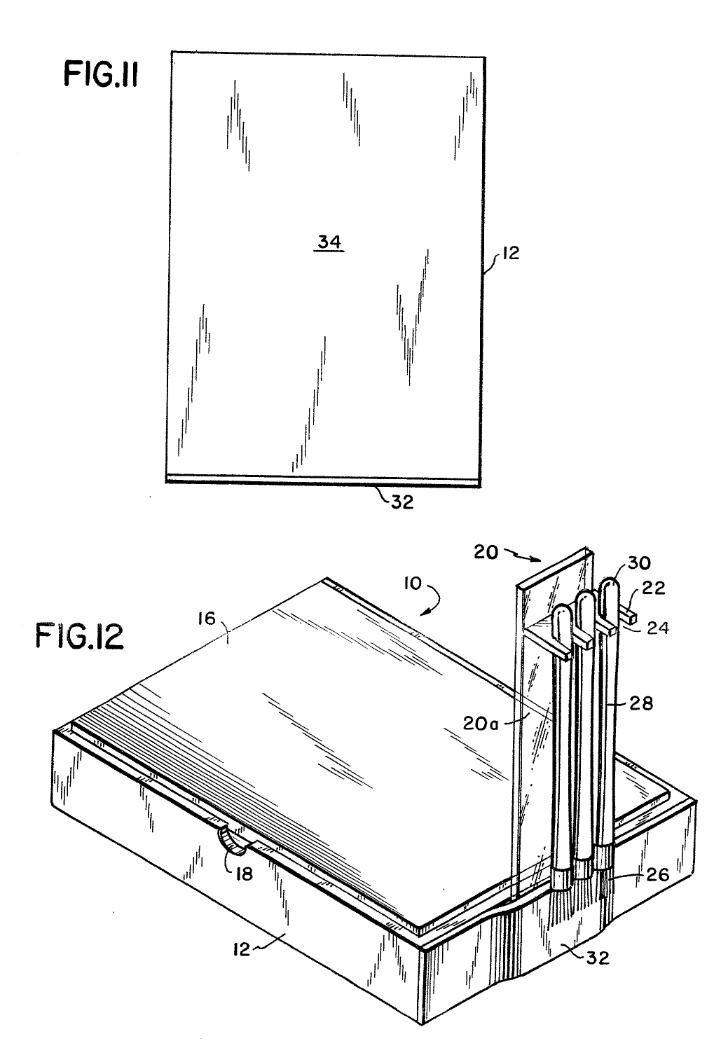

As seen in FIG. 2 the open box 12 is constructed to accommodate a plurality of artist brush hanger members referred to generally by the reference numeral 20 which are preferably fabricated of transparent Lucite. The hanger members 20 are shown in greater detail in FIGS. 6-9 in which each hanger member 20 has a ledge or platform 22 extending substantially perpendicular to the elongated rectangular part 20a of the hanger member 20. The ledge has cutouts 24 spaced along the ledge. As seen in FIG. 10, the artist brush 26 is provided with a handle 28 in which the end 30 remote from the brush part is enlarged, or slightly bulbous so that the handle will not slip or drop out of the cutouts 24 of the ledge when the brushes are placed on the hangers. FIG. 11 is illustration of the back or bottom 34 of the box 12 supported on a flat surface.

As seen in FIG. 12, the box is provided with a bracket 32 on the end wall of the case so that the hanger member 20 can be removed from the interior of the box 12 and removably inserted behind the bracket 32, thus holding the hanger member in an upright position with the artist brushes suspended there from so that the user can conveniently access the brushes for painting. Consequently, the artist can store or transport his or her paint brushes in the present artist paint brush case, and also to have the opportunity to utilize the paint brush case as a stand for mounting the hanger member with paint brushes suspended therefrom, ready for use by the artist.

While there has been shown and described a single embodiment of the present invention, it will be understood that various changes in form and details of the illustrated artist paint brush case and its operation can be made by those skilled in the art without departing from the spirit of the invention. It is the intention, therefore, to be limited only as indicated by the scope of the claims appended hereto.

What is claimed is:

1. An artist paint brush case comprising an open box, a cover for said box, at least one paint brush hanger member having an elongated rectangular element with a ledge extending substantially perpendicular to said rectangular element, spaced grooves in the edge of said ledge for hanging artist brushes and each of said brushes having a handle in which the end remote from said brush is enlarged to prevent the brush handle from falling out of said groove.

2. A paint brush case comprising an open box, a cover for said box, at least one paint brush hanger member having an elongated rectangular element in which opposite sides of said element have linear surfaces that frictionally engage the inner surface of the top and bottom of said box respectively, a platform on said rectangular element projecting perpendicular to said rectangular element, spaced openings in the edge of said platform, and each of said brushes having a handle with an enlarged end remote from said brush so that the handle is held in said opening with said brush in a downward position.

3. A rectangular paint brush case comprising an open box, a cover for said box, at least one brush hanger member having an elongated rectangular element with a ledge adjacent to the top of said element and extending substantially perpendicular to said rectangular element, spaced openings in the edge of said ledge for hanging artist brushes therein by their handles, each of said brushes having an enlarged end remote from the said brush to prevent said brush from falling out of the opening, and means on the outside of one of the walls of said rectangular paint brush case for removably mounting said elongated rectangular element with said paint brushes suspended from the openings in said ledge on the exterior of said case.

4. A paintbrush case as claimed in claim 1 wherein said rectangular element is fabricated of plastic.

5. A paintbrush case as claimed in claim 2 wherein each of said paintbrushes has a handle with an enlarged end that prevents the handle from falling out of said platform.

6. A paintbrush case as claimed in claim 3 wherein said means on the outside of one of the walls of said paintbrush case is a bracket.

7. A paintbrush case as claimed in claim 3 wherein said brush hanger member is fabricated of a transparent Lucite.
